(19) United States
(12) Patent Application Publication
(10) Pub. No.: US 2007/0271150 A1
(43) Pub. Date: Nov. 22, 2007

(54) ONLINE PURCHASE OPTIMIZATION

(76) Inventor: Harish Abbott, Menlo Park, CA (US)

Correspondence Address: PERKINS COIE LLP, P.O. BOX 2168, MENLO PARK, CA, 94026, US

(21) Appl. No.: 11/419,184

(22) Filed: May 18, 2006

Related U.S. Application Data
(60) Provisional application No. 60/747,538, filed on May 17, 2006.

(51) Int. Cl. G06Q 30/00

(52) U.S. Cl. 705/26

(57) ABSTRACT

A system, method and apparatus for online purchase optimization is presented in various embodiments. In one embodiment, a method is provided. The method includes receiving a selection of a plurality of items. The method also includes enumerating a list of complete sets of combinations of items of the plurality of items. The method further includes determining prices of the complete sets of combinations of items of the plurality of items. Also, the method includes choosing a lowest price from the prices of the complete set of combinations of items of the plurality of items. Moreover, the method includes presenting the lowest price to a user. Additionally, the method includes receiving approval to purchase the selection of the plurality of items at the lowest price and payment from the user with one click of a user input device.

### CLAIM OF PRIORITY

This application claims priority to U.S. Provisional Patent application Ser. No. 60/747,538, filed on May 17, 2006, which is hereby incorporated herein by reference.

### BACKGROUND

The first internet shopping sites started in the mid-90s with a model where consumer products were merchandised and sold on the company's website and the products were subsequently shipped to the customers from inventory stocked in fulfillment centers either owned by the sites or their partners. Towards the end of the 90's a new breed of websites cropped up—price comparison (or comparison shopping) sites that simply compared prices from various traditional e-commerce sites (or e-tailers) for any given product. A customer visiting one of these new sites was able to search for products in various categories and compare prices for those products at various e-tailers. Since most e-tailers had affiliate programs that offered attractive commissions to websites that sent purchasing customers their way, the most popular business model for price-comparison sites was to join the affiliate programs of all the e-tailers and generate revenues from customer clicks on their price comparison pages, which directly led to the e-tailers' websites. This still is the most popular business model.

After the year 2000, there has been a steady growth in the number of traditional e-commerce sites. As internet usage and broadband penetration grew, so did the profitability of e-tailers. Today, there are thousands of such websites that sell everything from sandwiches to books to real estate. The number is expected to grow. With the growth in the number of e-tailing sites, price comparison gained significant prominence and has become an essential step in the online shopping process of many customers.

In September of 2005 45.3 million consumers used comparison shopping sites to search for the best deals on the internet. Some of the larger comparison shopping sites have upwards of hundreds of millions of dollars in Gross Merchandise Sales. With this growth, the business model also evolved. Popular comparison shopping sites have started charging merchants for prominent placement of their products. This has further helped improve the profitability of the price-comparison sites.

In spite of this tremendous growth in business, few price-comparison sites have offered any significant new features to their shopping customers. Almost all comparison shopping sites help customers find the cheapest merchant to buy a single product from, with shipping and taxes included. For example, shopping.com, a popular comparison shopping site can provides the best price for a Sony LCD monitor with shipping and taxes across many merchants. However, no one addresses the customers that wish to purchase more than one product.

The ability to find the cheapest total price for a bundle of products is a potentially desirable feature from two standpoints—it saves money and it saves time. For example, to buy a printer and cables that attach it to the desktop, a customer today has to do a comparison shopping search for two items separately. Then, to find the optimal way to buy the bundle of two items, the customer has to do manual computation on prices taking into consideration each merchant shipping rate, shipping policies, tax rates, volume discounts and coupons. A one-click multi item price comparison will thus potentially save time and money. Therefore, it may be useful to provide a system that allows a user to search for an optimal or near-optimal price across a range of merchants for a set of items.

### BRIEF DESCRIPTION OF DRAWINGS

The present invention is illustrated by way of example in the accompanying drawings. The drawings should be understood as illustrative rather than limiting.

FIG. 1 illustrates a matrix of products and vendors.

FIG. 2 illustrates an optimal purchase plan for the matrix of FIG. 1.

FIG. 3 illustrates an embodiment of a set of options for purchasing a set or products.

FIG. 4 illustrates an embodiment of a matrix of available subsets of merchants and products.

FIG. 5 illustrates an embodiment of a process of choosing an optimal or near-optimal purchase plan.

FIG. 6 illustrates an embodiment of a process of completing an optimal or near-optimal purchase plan.

FIG. 7 illustrates an embodiment of a network which may be used for optimal and near-optimal purchases.

FIG. 8 illustrates an embodiment of a machine which may be used in the network of FIG. 7.

FIG. 9 illustrates an embodiment of a system of transacting with a near-optimal or optimal purchase plan.

FIG. 10 illustrates another embodiment of a system useful in transacting with a near-optimal or optimal purchase plan.

FIG. 11 illustrates an embodiment of a process of fulfilling an order.

FIG. 12 illustrates an embodiment of determining a low price for an order.

### DETAILED DESCRIPTION

A system, method and apparatus is provided for online shopping optimization. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

This problem of finding the optimal price, including shipping, taxes, discounts, coupons may be solved by searching through all the possibilities efficiently in a user friendly way, and potentially requiring approximately minimum clicks and time.

In an embodiment, a method is provided. The method includes receiving a selection of a plurality of items. The method also includes preparing a data structure representing a list of complete sets of combinations of the plurality of items. The method further includes ranking the list of complete sets of combinations of the plurality of items.

Additionally, the method includes determining prices of the complete sets of combinations of items of the list of complete sets of combinations of items in order of the combinations in the list. The method also includes maintaining a lowest price of the plurality of items among the list of complete sets of combinations of items. Moreover, the method includes choosing the lowest price from the prices of the complete set of combinations of items of the plurality of items. Also, the method includes presenting the lowest price to a user.

In another embodiment, a method is provided. The method includes receiving a selection of a plurality of items. The method also includes determining prices of complete sets of combinations of items of the plurality of items. The method further includes choosing a lowest price from the prices of the complete set of combinations of items of the plurality of items.

Being able to find the cheapest way to purchase multiple products would not only be desirable but it will also potentially revolutionize the shopping space. With such a system, Merchants would find that lowering the price of one product to raise the price of another (generally referred to as loss-leader strategy) does not work as well. Merchant 3 above is a prime example of such a strategy. Customers will get a much fairer picture of the overall cost to them and merchants will be forced to focus on improving their operations and productivity in order to lower prices and compete, instead of shrewd pricing strategies.

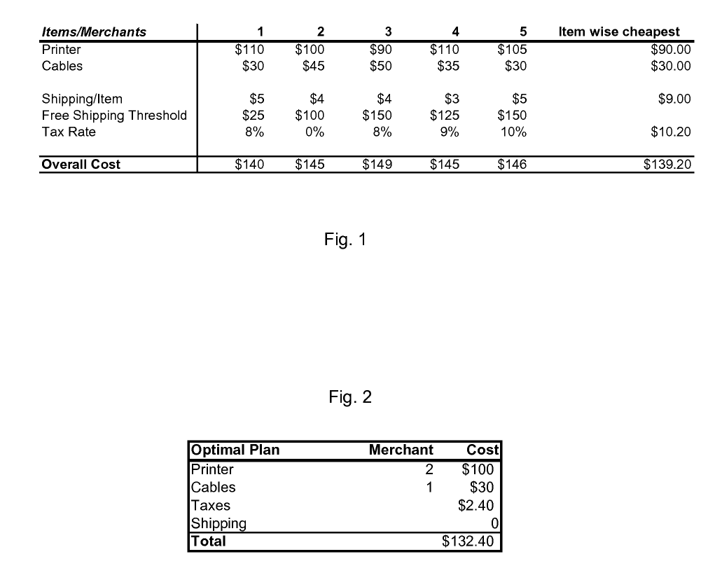

The example below, based on FIG. 1, illustrates the case of buying two items, printer and cables from five merchants namely (1,2 . . . 5). As can be seen from the example the most common human approach could be to go with merchant 3 who is offering significant savings on the printer. In this case the consumer ends up paying $149.00—highest among all the alternatives available. Another approach that will involve multiple clicks would be to find the cheapest merchant for each of the items. This scenario is illustrated in the right of the table. The consumer will pay a total of $139.20 resulting in a net savings of $9.80.

However none of the above two scenarios is optimal. In fact it will take a significant amount of time and calculation for a consumer to figure out the optimal way to buy—one that lowers the total cost to the buyer. The table of FIG. 2 illustrates the lowest way to buy the two items at a price of $132.40—an additional $6.80 savings over the cheapest item buy.

While it is easy to find the cheapest price of a single product from M merchants, it is non-trivial to find the optimal way to buy N products from M merchants. In the former case, there are a total of n possibilities to consider, but in the latter, the possibilities are potentially exponential in m. As the number of products grows, the complexity grows exponentially. This poses a significant challenge for websites where customers expect immediate responses; an efficient real-time algorithm to solve this problem seems necessary before offering the feature on comparison shopping sites. The discontinuity of shipping rates with free shipping thresholds employed by many merchants today makes the problem more difficult. The widespread used product marketplaces and the differential tax treatment of new and used products introduces new discontinuities in the cost function making it a mathematically complex problem.

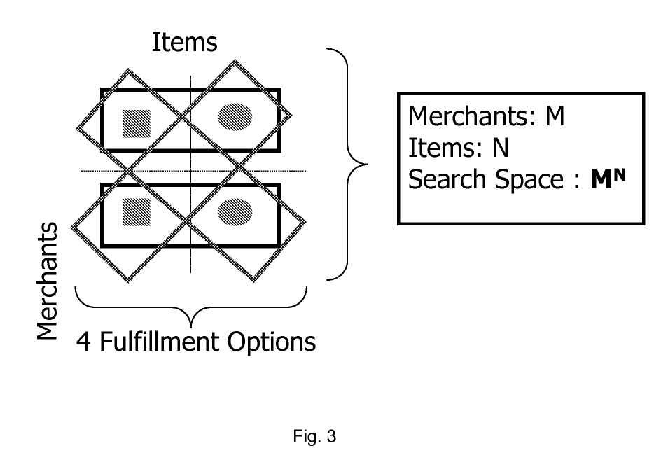

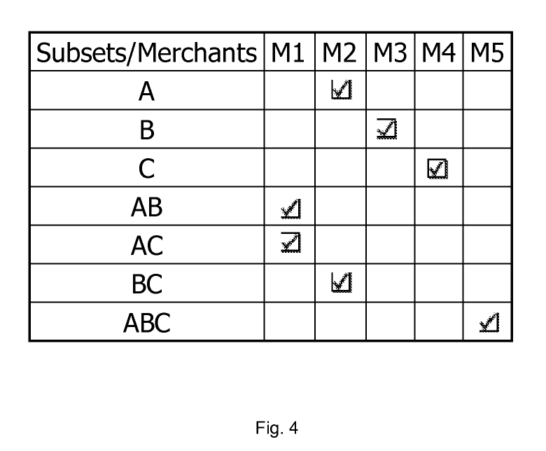

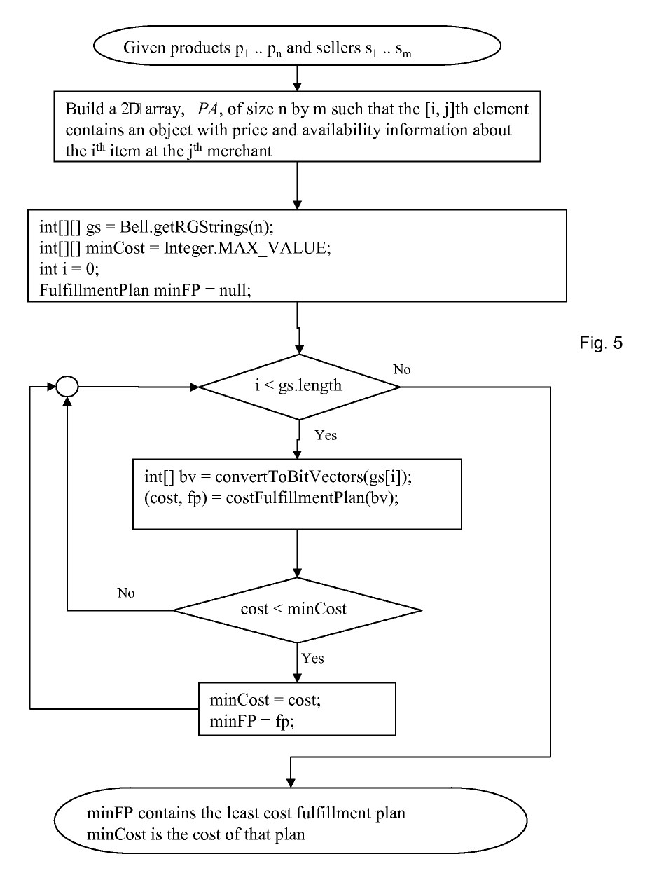

As an example, consider a two item and two merchant scenario. As illustrated in FIG. 3, one square and one circle toy are desired. There are two merchants who have these items available. As can be seen, there can be four possible ways to buy this set of items from the two merchants and each possibility could result in a different price point to the consumer.

Extending this example to M merchants and N items, one way to analyze the space is considering that we can buy the 1^{st} item from M merchants and the 2^{nd} item also from M merchants, the 3^{rd} item also from M merchants and so on. Hence the total search space could be thought of as

M×M×M . . . ×M(Ntimes)=M^{N}

As can be seen from this naive modeling, the complexity of the search space goes up exponentially with the number of items. In this scenario a comparison shopping situation with 5 items and 20 merchants can result in a space of 3.2 million possible fulfillment options—a large data set to be searched in few seconds.

The above problem can easily be reduced to a form of an NP Hard problem and has been well documented in the operations research and theoretical computer science literature. A brief description of the problem is as follows:

Consider a finite set of n elements E. Let all of its subsets {Cⱼ} be given and one must choose subsets that form a partition of E. That is, one needs to find a set of indices J such that ∪_{j∈J}Cⱼ=E and ∩_{j∈J}Cⱼ=Ø. That is the subsets of E chosen are not null and are mutually exclusive. For example for a set {A,B,C} a possible combination is {{A}, {BC}}. An inappropriate combination may be {{AB},{BC}}—there should be no duplicate elements within the subsets.

As E is finite, it may be represented as a boolean vector of n true entries and one may represent a subset Cⱼ as a boolean vector of n entries too, but with true values corresponding to included elements. That is, the i^{th} entry of the vector is true if the i^{th} element is in Cⱼ. Now one may form a matrix A containing the vectors of the subsets as columns. Accordingly, this matrix has n rows and p (number of subsets) columns. A solution of the problem may be found as a solution of the following system of equations:

$${\sum }_{j = 1}^{p} {a}_{ij} {x}_{j} = 1 , \\ i = 1 , … , n$$

Here and throughout this document, the notation identifies boolean values with {0,1} i.e., false=0, true=1. If each element of the set E is an item that a user wants to buy then each subset of the set E is a potential shipment in an optimal choice of shipments. Assuming that one knows the best possible way to buy a shipment across a universe of merchants and denoting that SCⱼ as Shipment Cost, then one wants to minimize the following cost function subject to above constraints.

$${\sum }_{j = 1}^{p} {SC}_{j} {x}_{j}$$

### This is the integer programming formulation of the problem.

The above integer program can be solved using third-party solvers. However, the integer programming solutions ignores some peculiar characteristics of this problem in the context of the comparison shopping space and hence takes a very long to solve the problem—an unacceptable timeframe for a consumer buying decision.

Thus, it may be useful to formulate and solve the above problem in an acceptable time frame for a practical problem size. Based on consumer research the acceptable time frame would be within 2-3 seconds to solve the problem and to paint the next page to the consumer with the optimization results. The practical problem size is an upper limit on the number of items an average consumer would want to buy at one time and a reasonable number of merchants. Based on observations, 10 or less items and less than 50 merchants forms a good practical set for such a problem—addressing needs for consumer choice and potential numbers of items.

One may approach this problem by looking through the possible shipments in an optimal fulfillment plan. It can be easily observed that each shipment in an optimal fulfillment plan would be one of the subsets of all the subsets possible from a set of items. The set of all the subsets of a set is called a Power Set. Given a set S the power set of S is the set of all the subsets. The order of power set of a set of order n is 2ⁿ. Hence the power sets are larger than the sets associated with them. One can denote power set of a subset S as p(S).

Now consider the proposition that any fulfillment plan for the three items can be represented as a linear combination of the subsets of the Power Set using binary [0,1] as coefficients. Given this representation and proposition, one can also observe that any constituent shipment of the optimal fulfillment plan will always be ordered from the merchant that can supply it at the cheapest price including taxes and shipping. This is a potentially useful observation which relies on the fact that shipment, taxes and discounts work for a shipment and not for individual items. The discontinuity of free shipping thresholds can also be represented fully using a shipment level granularity.

With the above two propositions, it becomes apparent that one can create subsets of items and can search through the subsets to find the best option to buy each subset. For each subset there will exist one and only price to buy it, from more than one merchants in case of a tie, for that to be in the optimal fulfillment plan.

However, this does not conclude the entire search. Once one has the subsets, one needs to go through all the possible combinations of subsets that will form the supersets. This is nothing other than all the ways a set of N elements can be partitioned into nonempty subsets.

The number of such plans for a set or subset is called the Bell Number BN. The number of Bell numbers grows exponentially with N. For N=1, 2 . . . 15, the Bell numbers have the values 1, 1, 2, 5, 15, 52, 203, 877, 4140, 21147, 115975, 678570, 4213597, 27644437, 190899322. The number of Bell numbers for a given set is given by the exponential generating function

$${e}^{{e}^{x} - 1} = {\sum }_{n = 0}^{∞} \frac{{B}_{n}}{n !} {x}^{n} .$$

The Bell numbers can also be generated using the recurrence relation

$${B}_{n + 1} = {\sum }_{k = 0}^{n} {B}_{k} ( \begin{matrix}n \\ k\end{matrix} ) ,$$

Hence, considering the way the problem has been decomposed, the overall problem complexity is

O(2^{N}M+B^{N})

This is still a very large number that grows exponentially with N. However the number is only linearly dependent on M. One can use this representation of the problem as the core step to design a fast real time solution to finding the optimal or near-optimal way to buy a bundle of items from a set of merchants.

Solution Approach

One can use new approaches to solve this exponentially hard problem in a space bounded by acceptable time and practical problem size. In the following is described an approach to solve the search using bit vector data modeling, caching, pruning heuristics and object oriented multi-threaded tree pruning techniques specifically designed to solve a multi-item comparison shopping problem.

Bit Vector Representation of Shipments

One can use bit vectors to speed up the operations. Due to the way modern computers, which use the von-Neumann architecture, are built, operations on integers tend to be much faster than arrays. This is primarily due to the fact that elements of data have to be loaded into registers before an operation can be performed on them. An operation on an integer takes one step to load the integer into a register while in case of an array; it will take as many steps as there are elements in the array as each of the array elements will have to be loaded into registers. One can exploit this feature in the implementation of the algorithm to achieve tremendous speedups over naïve or brute-force implementations.

For example, given an order containing 4 items, say A, B, C, and D, one can give them bit vectors positions 1, 2, 3, and 4 respectively. A shipment containing only items A and C will be represented as the integer 5, whose bit-vector representation is 101. This bit-vector representation of shipments and orders has several advantages:
For any given shipment one can find out what corresponding shipment can round out the order by simply performing an XOR with the bit-vector representation of the order, which in the above case would be 1111 (or the integer 15).
To store and retrieve information about shipments, one can simply use an array with the shipment bit-vector as the index into the array.

I. Partition of Optimal Subset

One can use Bell numbers and restricted growth strings (RG strings) to find the various partitions of a given order. A restricted growth string is a way of representing a partition of a given set. For example for set {A,B,C} we have the following partitions

{{A}{B}{C}}, {{A,B}{C}}, {{A,C}{B}}, {{A}{B,C}} and {{A,B,C}}

So a Restricted Growth string (or RG string) is a string a[1 . . . n] where a[i] is the block in which element i occurs. Each partition represents a way of fulfilling the given order through various shipments. As the Bell numbers grow exponentially so do the restricted growth strings. Each growth string corresponds to a fulfillment plan, which in itself is composed of shipments. Hence the least cost of a fulfillment plan (RG String) can be computed by simply summing the lowest costs of each of the constituent shipments.

One can use a hybrid approach to create restricted growth strings for small size orders and to use a cached version of a compressed representation of pre-computed restricted growth string.

Using the Restricted growth string in a binary representation form, one approach is to enumerate every option and price every constituent shipment. An option like that works well for 3-4 items but it slows tremendously as one scales to large order sizes. Hence one can use an on-the-fly generation and pricing component in the algorithm to speed processing.

The algorithm for generating restricted growth strings is based on an algorithm presented by George Hutchinson in CACM 6 (1963). The growth strings can then be transformed into a combination of shipments. Since a character at the ith position in the RG string indicates the shipment the i^{th} item belongs to, one can accomplish the required transformation by walking through the given RG string and adding each item to the respective shipment indicated by the corresponding character in the RG string. The above mentioned transformation of RG strings into shipments can be accomplished with highly efficient processor operations such as bit-wise OR, shift, and array lookups.

Once converted, the resultant array of bit vectors represents a fulfillment plan where the individual elements of the array are nothing but shipments that constitute the fulfillment plan. Once the fulfillment plan array is generated, computing the cost of the plan is straightforward; it simply involves computing the cost of individual shipments and summing them to get the overall cost of the fulfillment plan.

II. Pruning the Decision Tree

After running through several merchants and their live inventory and shipping and tax policies two observations become apparent

1) One will (essentially) never split a shipment for ordering purposes from a merchant. For example, if one is going to order {A,B,C} from a merchant there is essentially no possible way to save costs by ordering {A,B} separately and {C} separately from the same merchant. While circumstances may exist where this is true, none were observed, so it may be taken as a given.

2) If one can get all three items from a merchant then the likelihood that it is the cheapest option is very high. It is by no means guaranteed but it has a high probability of being cheap.

Using the above two observations, one can rank-order possible fulfillment options in order of their expected probability of being the optimal choice. Further observations suggested that an ordering is ascending order of the maximum of the block numbers (0,1,2 above) yields good results for pruning. Hence the first fulfillment plan to examine will be {{A,B,C}} with a sum of block number=0. The ties are first broken with largest shipment size and then arbitrarily. {{A,C,D}, {B}} will precede {{A,B}, {C,D}} because the former has a shipment size of 3 as compared to 2.

One may start from the sorted list of fulfillment options or restricted growth strings. Thus, start the search from the largest shipment, i.e. one that contains all the items, and proceed to single item shipments. While processing a given growth string, one can check to make sure that no single shipment costs more than the lowest cost fulfillment plan until the current point in search. This is a form of short-circuit evaluation where one can discontinue the search if one we can establish that the current fulfillment plan has no chance of being the lowest cost plan.

One implementation does not require the process to price a shipment unless it is needed. This way one can eliminate considering and pricing many shipments—potentially a computationally expensive step. While this does not reduce the complexity of the problem, it makes a significant difference in the average case.

III. Caching Results

Computing the cost of various fulfillment plans requires computing the cost of the underlying shipments. Caching reduces the number of operations exponentially at the expense of a little extra memory. One can combine the caching process per shipment with the above-described pruning algorithm to generate an efficient and very fast method of reaching the optimality or near-optimality using minimal computing resources.

Large Orders

For large orders, the problem becomes potentially unsolvable for practical use. While few customers ever purchase 15 different products in a single order, one may see use-cases for orders with more than 20 different products. For instance, libraries and corporations tend to order dozens of books at a time.

One can solve the problem of large orders by breaking it down into smaller problems and efficiently combine the results to arrive at an approximate solution. Even though the solution thus computed is not guaranteed to be optimal, it offers significant savings to customers over a naive grouping. One can try to eliminate edge cases by applying sampling techniques. A given large order of N items is randomly broken down into ceiling(N/15) virtual orders, each of which consists of N/ceiling(N/15) items approximately. Each of the virtual orders is solved separately and its minimum cost obtained. The costs are all added to yield the total overall cost of the original large order. This process is repeated N/5 times with different random partitioning each time. At the end, the partition that yields the lowest overall cost for the large order is chosen as the solution. This process can be further enhanced by randomizing the number of items in each virtual order without changing the total number of virtual orders.

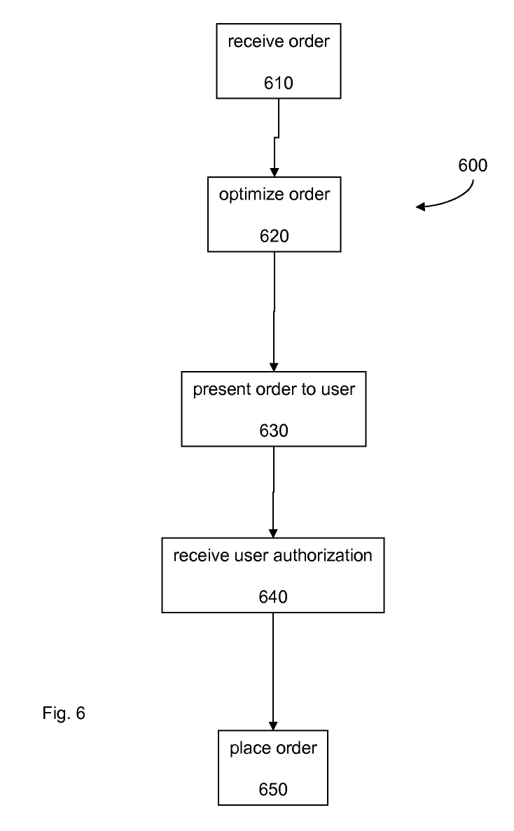

Turning to FIG. 6. a general process of ordering a set of items is illustrated. The process 600 includes receiving a desired order from a user, optimizing the order from a set of merchants, presenting the optimized order, receiving authorization to place the order, and placing the order. Process 600 and other processes of this document are implemented as a set of modules, which may be process modules or operations, software modules with associated functions or effects, hardware modules designed to fulfill the process operations, or some combination of the various types of modules, for example. The modules of process 600 and other processes described herein may be rearranged, such as in a parallel or serial fashion, and may be reordered, combined, or subdivided in various embodiments.

At module 610, an order is received from a user. Such an order can be a newly specified set of items to purchase, or can be a request to reorder a set of items which is part of a standing order, for example. At module 620, the order is optimized based on a set of merchants available to provide all or part of the order. At module 630, the optimized order is presented to the user for approval—allowing the user to veto merchants considered untrustworthy or to reconsider the order based on overall price, for example. At module 640, the user authorizes the order. As a result, at module 650, the order is placed with the appropriate merchant or merchants, and tracking or confirmation information is provided to the user.

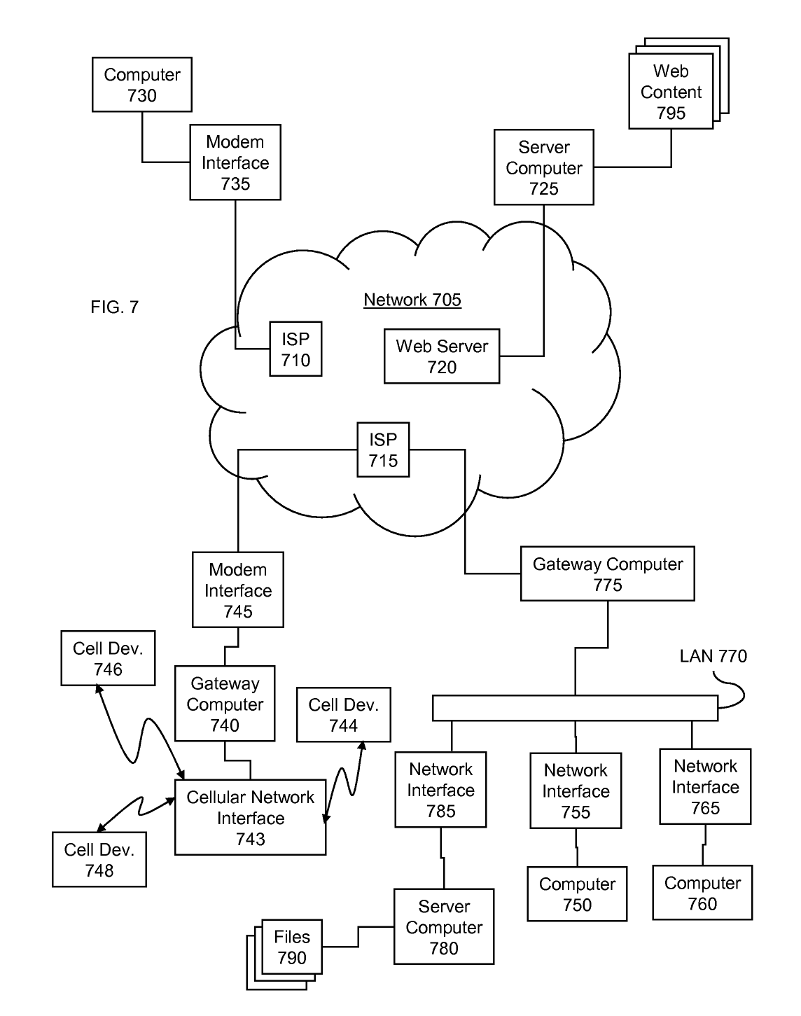

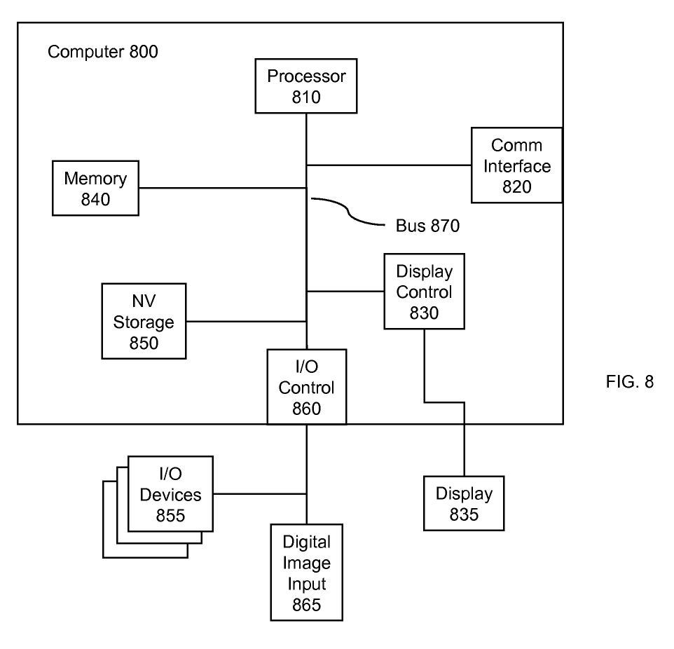

The following description of FIGS. 7-8 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet, along with a cellular network and related cellular devices. The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Cellular network interface 743 provides an interface between a cellular network and corresponding cellular devices 744, 746 and 748 on one side, and network 705 on the other side. Thus cellular devices 744, 746 and 748, which may be personal devices including cellular telephones, two-way pagers, personal digital assistants or other similar devices, may connect with network 705 and exchange information such as email, content, or HTTP-formatted data, for example. Cellular network interface 743 is coupled to computer 740, which communicates with network 705 through modem interface 745. Computer 740 may be a personal computer, server computer or the like, and serves as a gateway. Thus, computer 740 may be similar to client computers 750 and 760 or to gateway computer 775, for example. Software or content may then be uploaded or downloaded through the connection provided by interface 743, computer 740 and modem 745.

Client computer systems 730, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 750 and 760, although as shown in FIG. 7, the connections are not the same as for more directly connected computer systems. Client computer systems 750 and 760 are part of a LAN coupled through a gateway computer 775. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a personal device that can be used as a cellular telephone (744, 746 or 748) or similar personal device. Such a device can be used to perform many functions depending on implementation, such as telephone communications, two-way pager communications, personal organizing, or similar functions. The computer system 800 interfaces to external systems through the communications interface 820. In a cellular telephone, this interface is typically a radio interface for communication with a cellular network, and may also include some form of cabled interface for use with an immediately available personal computer. In a two-way pager, the communications interface 820 is typically a radio interface for communication with a data transmission network, but may similarly include a cabled or cradled interface as well. In a personal digital assistant, communications interface 820 typically includes a cradled or cabled interface, and may also include some form of radio interface such as a Bluetooth or 802.11 interface, or a cellular radio interface for example.

The computer system 800 includes a processor 810, which can be a conventional microprocessor such as an Intel pentium microprocessor or Motorola power PC microprocessor, a Texas Instruments digital signal processor, or some combination of the two types or processors. Memory 840 is coupled to the processor 810 by a bus 870. Memory 840 can be dynamic random access memory (dram) and can also include static ram (sram), or may include FLASH EEPROM, too. The bus 870 couples the processor 810 to the memory 840, also to non-volatile storage 850, to display controller 830, and to the input/output (I/O) controller 860. Note that the display controller 830 and I/O controller 860 may be integrated together, and the display may also provide input.

The display controller 830 controls in the conventional manner a display on a display device 835 which typically is a liquid crystal display (LCD) or similar flat-panel, small form factor display. The input/output devices 855 can include a keyboard, or stylus and touch-screen, and may sometimes be extended to include disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the device 800.

The non-volatile storage 850 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 800. Rather, a mass storage device on another computer is typically used in conjunction with the more limited storage of the device 800. Some of this data is often written, by a direct memory access process, into memory 840 during execution of software in the device 800. One of skill in the art will immediately recognize that the terms “machine-readable medium” or “computer-readable medium” includes any type of storage device that is accessible by the processor 810 and also encompasses a carrier wave that encodes a data signal.

The device 800 is one example of many possible devices which have different architectures. For example, devices based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

In addition, the device 800 is controlled by operating system software which includes a file management system, such as a disk operating system, which is part of the operating system software. One example of an operating system software with its associated file management system software is the family of operating systems known as Windows CE® from Microsoft Corporation of Redmond, Wash., and their associated file management systems. Another example of an operating system software with its associated file management system software is the Palm® operating system and its associated file management system. The file management system is typically stored in the non-volatile storage 850 and causes the processor 810 to execute the various acts required by the operating system to input and output data and to store data in memory, including storing files on the non-volatile storage 850. Other operating systems may be provided by makers of devices, and those operating systems typically will have device-specific features which are not part of similar operating systems on similar devices. Similarly, WinCE® or Palm® operating systems may be adapted to specific devices for specific device capabilities.

Device 800 may be integrated onto a single chip or set of chips in some embodiments, and typically is fitted into a small form factor for use as a personal device. Thus, it is not uncommon for a processor, bus, onboard memory, and display/i-o controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

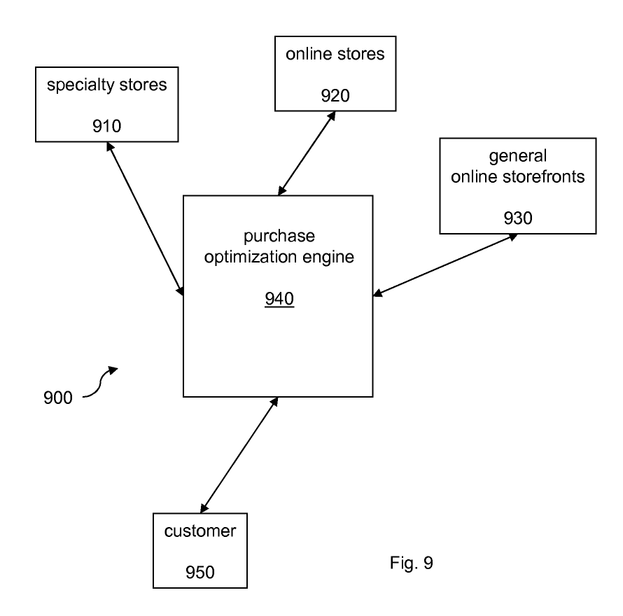

Turning to the overall system illustrated in FIG. 9, a system which may be used for purchase of specialized products in an optimized manner is provided. System 900 involves various types of vendors or providers, customers, and a purchase optimization engine. Specialty stores 910, online stores 920, and general online storefronts 930 each provide information about product availability to purchase optimization engine 940. Customer 950 interfaces with purchase optimization engine 940, specifying what products are desired. Purchase optimization engine 940 determines the best or near-best option for purchase of the products in question, and provides that result to customer 950. Customer 950 can then determine whether to purchase or not.

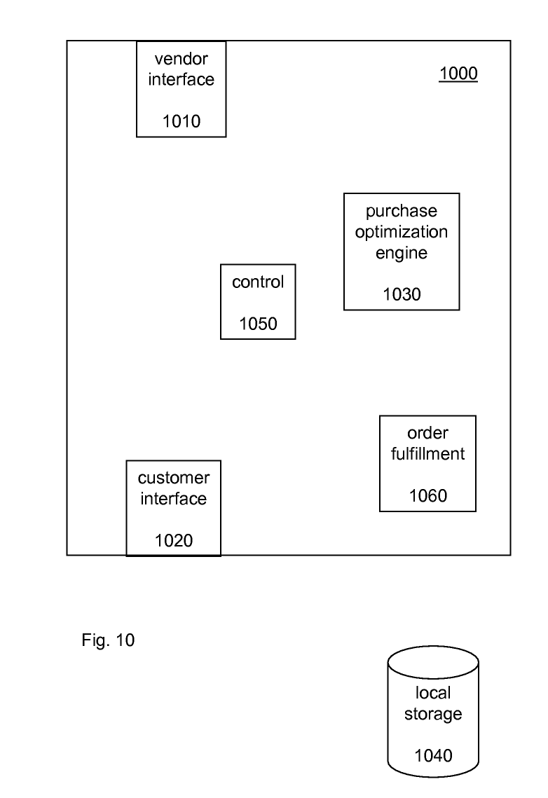

Another embodiment of a purchase optimization system is provided in FIG. 10. System 1000 includes a purchase optimization engine, user interface, vendor interface, order fulfillment module and a control module. Purchase optimization engine 1030 uses the methods and systems described above to determine an optimal or near-optimal combination of transactions for a given set of products. The set of products are provided by a customer through customer interface (or user interface) 1020. The actual products have information provided through vendor interface 1010, such as price, shipping terms and availability, for example. Once an order is approved by a customer through customer interface 1020, the order is fulfilled through order fulfillment module 1060. Module 1060 completes transactions with vendors through vendor interface 1010 and provides a confirmation to a customer through customer interface 1020. Each of these modules are controlled by control module 1050, which ensures communication occurs properly and information is stored properly. Information about vendors, products and users may be stored in local storage 1040, where it may be accessed and modified by the various modules.

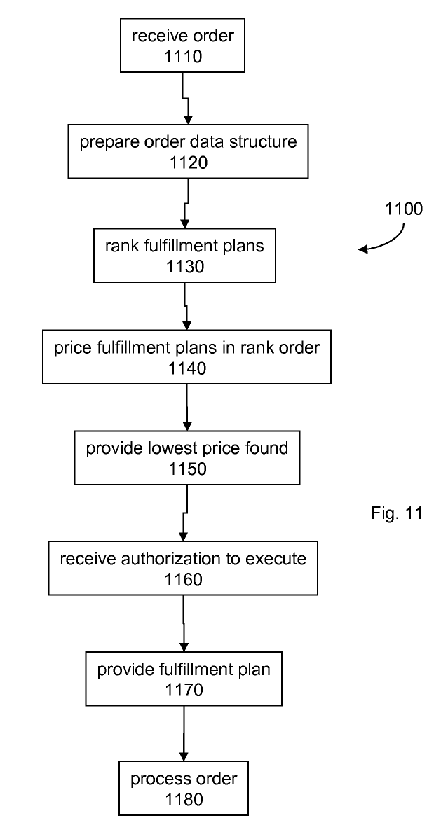

Various processes may be used to find the prices of subsets of an order, and thus to fulfill an order. FIG. 11 illustrates an embodiment of a process of fulfilling an order. At module 1110, an order is received as a set of items to be ordered, such as textbooks. At module 1120, an order data structure representing potential fulfillment plans is prepared, such that a set of all complete lists of combinations of items is enumerated within the data structure. At module 1130, the fulfillment plans are then ranked, such as by ranking complete plans first, plans with large groups from one merchant second, and so forth.

At module 1140, the fulfillment plans are priced in order of ranking—maintaining a low price, pricing each plan until its price is above that of the low price, and caching pricing results. At module 1150, the lowest price found is provided, such as to a user. At module 1160, authorization is received to execute the fulfillment plan for the order. At module 1170, the fulfillment plan is provided, such as to a user or to a system to execute the plan. The fulfillment plan provided corresponds to the low price maintained in module 1150. At module 1180, the fulfillment plan is executed and the order is thereby processed.

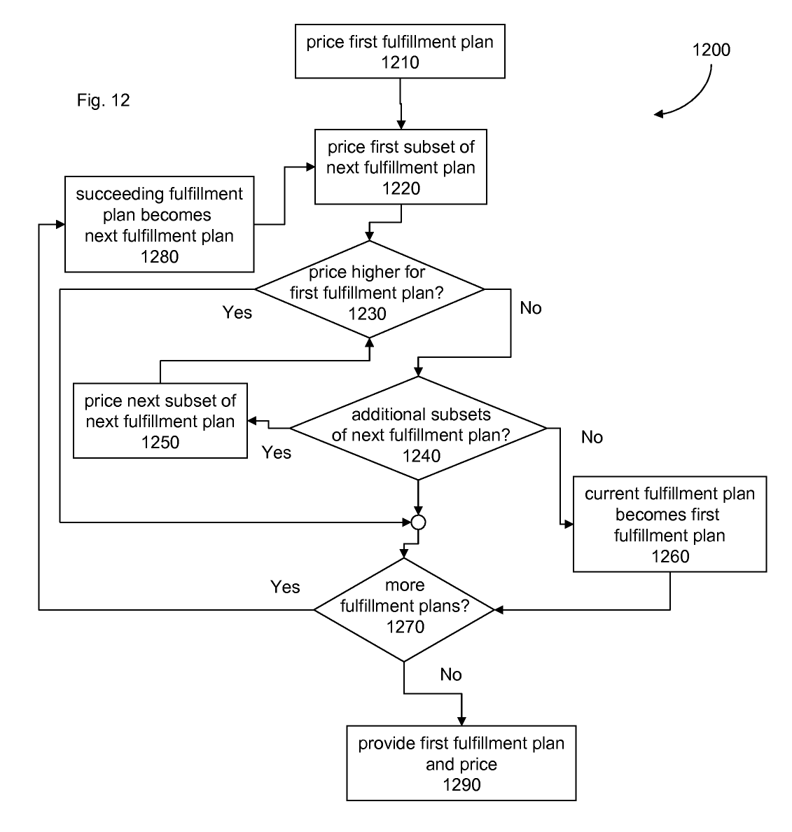

The process of determining a low price can be particularly informative, and can be implemented in a variety of ways. FIG. 12 illustrates an embodiment of determining a low price for an order. At module 1210, a first fulfillment plan in a rank ordered list (or any list) is priced. This may involve obtaining prices from a variety of merchants for the fulfillment plan, and may include considerations such as shipping cost, sales or value-added tax, coupons, specials or discounts, and other considerations. At module 1220, a first subset of a next fulfillment plan from the list is priced. At module 1230, a determination is made as to whether the price for the first subset of the next fulfillment plan is higher than the price of the first fulfillment plan (if yes, the next fulfillment plan can be ignored).

If the price found at module 1220 is not too high, the process moves to module 1240 and a determination is made as to whether there are additional subsets of the next fulfillment plan. If there are no more subsets of the next fulfillment plan (module 1240) and the price is lower than the first fulfillment plan (module 1230), then at module 1260, the next fulfillment plan becomes the new first fulfillment plan and the process moves to module 1270. If there are more subsets of the next fulfillment plan, then the next subset of the next fulfillment plan is priced at module 1250, and a determination is made as to whether the total price of the next fulfillment plan is higher than the price of the first fulfillment plan at module 1230. At any time at module 1230, if the price of the next fulfillment plan is higher than the price of the first fulfillment plan, the process moves to module 1270.

Whenever the process arrives at module 1270, a determination is made as to whether there are additional fulfillment plans. If so, a succeeding fulfillment plan (after the next fulfillment plan) becomes the next fulfillment plan at module 1280—and then the process moves again to module 1220. If there are no more fulfillment plans, the process ends at module 1290 with the price of the first fulfillment plan provided.

One skilled in the art will appreciate that although specific examples and embodiments of the system and methods have been described for purposes of illustration, various modifications can be made without deviating from the present invention. For example, embodiments of the present invention may be applied to many different types of databases, systems and application programs. Moreover, features of one embodiment may be incorporated into other embodiments, even where those features are not described together in a single embodiment within the present document.

What is claimed is:

1. A system, comprising:
a processor;
a memory coupled to the processor;
a user input device coupled to the processor;
an output device coupled to the processor;
a network interface coupled to the processor;
wherein the processor is to:
receive a selection of a plurality of items;
enumerate a list of complete sets of combinations of items of the plurality of items.
determine prices of the complete sets of combinations of items of the plurality of items;
and
choose a lowest price from the prices of the complete set of combinations of items of the plurality of items.

2. The system of claim 1, further comprising:
means for fulfilling an order based on the lowest price.

3. The system of claim 1, wherein:
the processor is further to fulfill an order based on the lowest price.

4. A method, comprising:
receiving a selection of a plurality of items;
enumerating a list of complete sets of combinations of items of the plurality of items.
determining prices of the complete sets of combinations of items of the plurality of items;
choosing a lowest price from the prices of the complete set of combinations of items of the plurality of items;
presenting the lowest price to a user.
receiving approval to purchase the selection of the plurality of items at the lowest price;
receiving payment from the user;
and
fulfilling an order for the user based on the selection of the plurality of items.

5. A method, comprising:
receiving a selection of a plurality of items;
enumerating a list of complete sets of combinations of items of the plurality of items;
determining prices of the complete sets of combinations of items of the plurality of items;
choosing a lowest price from the prices of the complete set of combinations of items of the plurality of items;
presenting the lowest price to a user;
and
receiving approval to purchase the selection of the plurality of items at the lowest price and payment from the user with one click of a user input device.

6. The method of claim 5, further comprising:
identifying a user in a log in process.

7. The method of claim 6, further comprising:
processing a transaction involving payment from the user for the selection of the plurality of items.

8. The method of claim 7, further comprising:
fulfilling an order for the user based on the selection of the plurality of items.

9. The method of claim 8, wherein:
the prices determined for the complete sets of combinations of items of the plurality of items include shipping costs.

10. The method of claim 6, wherein:
the prices are determined based on available prices from a single merchant.

11. The method of claim 6, wherein:
the prices are determined based on available prices from multiple merchants.

12. The method of claim 6, wherein:
the items are goods.

13. The method of claim 6, wherein:
the items are services.

14. The method of claim 6, wherein:
the items are a combination of goods and services.

15. The method of claim 6, wherein:
the prices determined for the complete sets of combinations of items of the plurality of items include discounts.

16. The method of claim 6, wherein:
the prices determined include shipping costs.

17. The method of claim 6, wherein:
the prices determined for the complete sets of combinations of items of the plurality of items include discounts and shipping.

18. The method of claim 6, wherein:
the method is implemented by a processor responsive to instructions embodied in a machine-readable medium.

19. The method of claim 5, wherein:
the items are textbooks.

20. The method of claim 6, wherein:
the prices determined include shipping costs based on shipping thresholds.
